(19) United States
(12) Patent Application Publication
(10) Pub. No.: US 2016/0141738 A1
(43) Pub. Date: May 19, 2016

(54) BATTERY PACK

(71) Applicant: Samsung SDI Co., Ltd., Yongin-si (KR)

(72) Inventor: Nohyun Kwag, Yongin-si (KR)

(21) Appl. No.: 14/857,459

(22) Filed: Sep. 17, 2015

(30) Foreign Application Priority Data
Nov. 18, 2014 (KR) 10-2014-0160687

(51) Int. Cl. H01M 10/6565; H01M 10/625; H01M 10/613

(52) U.S. Cl. CPC H01M 10/6565; H01M 10/613; H01M 10/625; H01M 2220/20

(57) ABSTRACT

One aspect is a battery pack for a transportation device, the battery pack including a plurality of bare cells and a case including a bottom portion including an air guide pipe. The case has a sidewall portion extending from the bottom portion so as to form a space accommodating the bare cells, the sidewall portion having an air hole passing therethrough. The air guide pipe is configured to transfer air received from the environment to the interior of the case via the air hole.

### INCORPORATION BY REFERENCE TO ANY PRIORITY APPLICATIONS

This application claims priority from Korean Patent Application No. 10-2014-0160687 filed on Nov. 18, 2014 in the Korean Intellectual Property Office, and all the benefits accruing therefrom under 35 U.S.C. 119, the contents of which in its entirety are herein incorporated by reference.

### BACKGROUND

1. Field

The described technology generally relates to a battery pack.

2. Description of the Related Technology

Unlike primary batteries that cannot be recharged, secondary batteries can be repeatedly charged and discharged. They are implemented in the form of a battery pack including battery cells and a charger/discharger circuit. Battery packs are widely used, for example, for small portable electronic devices such as cellular phones and camcorders, and as motor-driving power sources for hybrid or electric vehicles.

A typical bicycle requires significant physical strength, even at low speeds, in order to be ridden uphill. Therefore, electric bicycles are becoming more popular. Such electric bicycles are generally driven by an electric motor, and therefore battery packs can be used as the motor-driving power sources.

### SUMMARY OF CERTAIN INVENTIVE ASPECTS

One inventive aspect is a battery pack having both a waterproof capability and a heat-dissipating capability.

Another aspect is a battery pack including a plurality of bare cells; and a case including a bottom portion, a sidewall portion extending from the bottom portion to form a space to accommodate the bare cells and an air hole passing through the sidewall portion, wherein an air guide pipe is provided in the bottom portion of the case, the air guide pipe communicating to the air hole and inducing the air applied from the outside to the inside of the case.

The air guide pipe can include a first pillar protruding from the bottom portion in a first direction and a second pillar protruding in the first direction to be spaced a predetermined distance apart from the first pillar.

The air guide pipe can include a first region extending from the air hole and horizontally formed with respect to the air hole, and a second region extending from the first region and formed to be bent in a cochlea shape in an upward or downward direction from the air hole, the second region being formed such that a distance ranging from a first sidewall of the sidewall portion, which is closer to the second region than the first region, to its end, is 40% to 60% of a distance ranging from the first sidewall to the first region.

A moisture discharge hole communicating to the first sidewall can be formed in a portion of the second region positioned closest to the first sidewall.

The first region can be formed to be inclined at a predetermined angle with respect to the first sidewall.

The air guide pipe can be formed to have a U-shaped configuration and can include a first region extending from the air hole and horizontally formed with respect to the air hole, a second region extending from the first region and formed to be bent in an upward or downward direction from the air hole, and a third region extending from the second region and horizontally formed with respect to the first region, the third region being formed such that a distance ranging from the first sidewall of the sidewall portion, which is closer to the second region than the first region, to the third region, is smaller than a distance ranging from the first sidewall to the first region.

A moisture discharge hole communicating to the first sidewall can be formed in a portion of the second region positioned closest to the first sidewall.

The third region can include one or more dispersion regions each spaced a predetermined distance apart from each other and sequentially formed to be parallel with the first region, the dispersion regions having vertical widths sequentially increasing in a lengthwise direction.

The air hole can have an internal surface inclined with respect to an external surface of the case.

The case can include a first cover and a second cover covering a first side of the bare cells and a second side opposite to the first side, and the air hole and the air guide pipe can be provided in the first cover and the second cover. Another aspect is a battery pack for an transportation device, the battery pack comprising a plurality of bare cells and a case including i) a bottom portion including an air guide pipe and ii) a sidewall portion extending from the bottom portion so as to form a space accommodating the bare cells, wherein the sidewall portion has an air hole passing therethrough, wherein the air guide pipe is configured to transfer air received from the environment to the interior of the case via the air hole.

In the above battery pack, the air guide pipe comprises a first pillar protruding from the bottom portion in a first direction and a second pillar protruding in the first direction and spaced apart from the first pillar.

In the above battery pack, the sidewall portion has a first sidewall, wherein the air guide pipe comprises i) a first region extending from the air hole to be substantially horizontal with respect to the air hole and ii) a second region extending from the first region and formed to be bent in a substantially cochlea shape in an upward or downward direction from the air hole, wherein the second region is further formed such that the distance between the first sidewall and an end of the sidewall portion is about 40% to about 60% of the distance between the first sidewall and the first region, and wherein the first sidewall is closer to the second region than the first region.

In the above battery pack, the second region has a moisture discharge hole i) formed in a portion of the second region positioned closest to the first sidewall and ii) configured to discharge moisture to the outside of the first sidewall.

In the above battery pack, the first region is inclined at a predetermined angle with respect to the first sidewall.

In the above battery pack, the air guide pipe has a substantially U-shape and comprises i) a first region extending from the air hole to be substantially horizontal with respect to the air hole, ii) a second region extending from the first region to be bent in an upward or downward direction from the air hole, and iii) a third region extending from the second region to be substantially horizontal with respect to the first region, wherein the third region is further formed such that the distance between the first sidewall and the third region is less than the distance between the first sidewall and the first region, and wherein the first sidewall is closer to the second region than the first region.

In the above battery pack, the second region has a moisture discharge hole i) formed in a portion of the second region positioned closest to the first sidewall and ii) configured to discharge moisture to the outside of the first side wall.

In the above battery pack, the third region comprises one or more dispersion regions spaced apart from each other and sequentially formed to be substantially parallel with the first region, wherein the dispersion regions have vertical widths sequentially increasing in a lengthwise direction.

In the above battery pack, the air hole has an internal surface inclined with respect to an external surface of the case.

In the above battery pack, the bare cells have a first side and a second side opposite to the first side, wherein the case includes a first cover and a second cover covering the first and second sides, and wherein the air hole and the air guide pipe are provided in the first and second covers.

In the above battery pack, the electric transportation device comprises an electric bicycle, an electric motorcycle or an electric vehicle having at least four wheels.

Another aspect is a battery pack for an transportation device, the battery pack comprising a plurality of bare cells and a case including a first cover and a second cover opposite to the first cover, wherein the case is configured to accommodate the bare cells, wherein each of the first and second covers includes i) a bottom portion including an air guide pipe and ii) a sidewall portion extending from the bottom portion and having an air hole, and wherein the air guide pipe is configured to transfer air received from the environment to the interior of the case via the air hole.

In the above battery pack, the air guide pipe comprises a first pillar protruding from the bottom portion in a first direction and a second pillar protruding in the first direction and spaced apart from the first pillar.

In the above battery pack, the sidewall portion has a first sidewall, wherein the air guide pipe comprises i) a first region extending from the air hole to be substantially horizontal with respect to the air hole and ii) a second region extending from the first region and having a spiral shape.

In the above battery pack, the second region has a moisture discharge hole i) formed in a portion of the second region positioned closest to the first sidewall and ii) configured to discharge moisture to the outside of the first sidewall.

In the above battery pack, the first region is inclined at a predetermined angle with respect to the first sidewall.

In the above battery pack, the air guide pipe has a substantially U-shape and comprises i) a first region extending from the air hole to be substantially horizontal with respect to the air hole, ii) a second region extending from the first region to be bent in an upward or downward direction from the air hole, and iii) a third region extending from the second region to be substantially horizontal with respect to the first region, wherein the third region is further formed such that the distance between the first sidewall and the third region is less than the distance between the first sidewall and the first region, and wherein the first sidewall is closer to the second region than the first region.

In the above battery pack, the third region comprises one or more dispersion regions spaced apart from each other and sequentially formed to be substantially parallel with the first region, wherein the dispersion regions have vertical widths sequentially increasing in a lengthwise direction.

In the above battery pack, the air hole has an internal surface inclined with respect to an external surface of the case.

In the above battery pack, the bare cells have a first side and a second side opposite to the first side, wherein the case includes a first cover and a second cover covering the first and second sides, and wherein the air hole and the air guide pipe are provided in the first and second covers.

According to at least one of the disclosed embodiments, since the battery pack includes an air hole and an air guide pipe having waterproof and heat-dissipating capabilities, it is possible to prevent external moisture from permeating into the case while implementing a heat-dissipating effect through the externally applied air.

### BRIEF DESCRIPTION OF THE DRAWINGS

FIG. 1 is a perspective view illustrating a battery pack according to one embodiment.

FIG. 2 is a cross-sectional view taken along the line B-B of FIG. 1.

FIG. 3 is a perspective view illustrating some components illustrated in FIG. 2.

FIG. 4 is a cross-sectional view illustrating another embodiment of the battery pack shown in FIG. 2.

FIG. 5 is a cross-sectional view illustrating another embodiment of the battery pack shown in FIG. 2.

FIG. 6 is a cross-sectional view illustrating another embodiment of the battery pack shown in FIG. 2.

FIG. 7 is a cross-sectional view illustrating another embodiment of the battery pack shown in FIG. 2.

FIG. 8 is a cross-sectional view illustrating another embodiment of the battery pack shown in FIG. 2.

### DETAILED DESCRIPTION OF THE CERTAIN ILLUSTRATIVE EMBODIMENTS

Throughout the specification, it will be understood that when an element is referred to as being “connected to” another element, it can be “directly connected to” the other element or there are no intervening elements present. In addition, it will be understood that the terms “comprises” elements when used in this specification, specify the presence of stated elements, but do not preclude the presence or addition of one or more other elements.

In the following description, it will be understood that the spatially relative terms “one side” and “the other side” are intended to mean “the left” and “the right,” respectively, and the terms “upper side” and “lower side” are intended to mean “upward” and “downward,” respectively, in the figures.

In addition, the description of the spatially relative terms is not intended to limit forming positions of elements, unless it is particularly necessary to limit the forming positions by spatially relative terms.

Hereinafter, example embodiments are described in further detail with reference to the accompanying drawings. In this disclosure, the term “substantially” includes the meanings of completely, almost completely or to any significant degree under some applications and in accordance with those skilled in the art. Moreover, “formed on” can also mean “formed over.” The term “connected” can include an electrical connection.

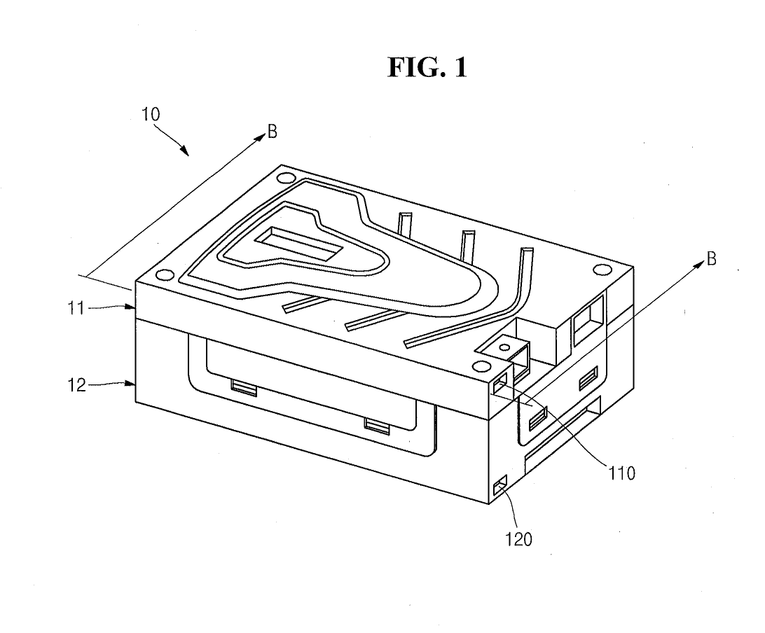

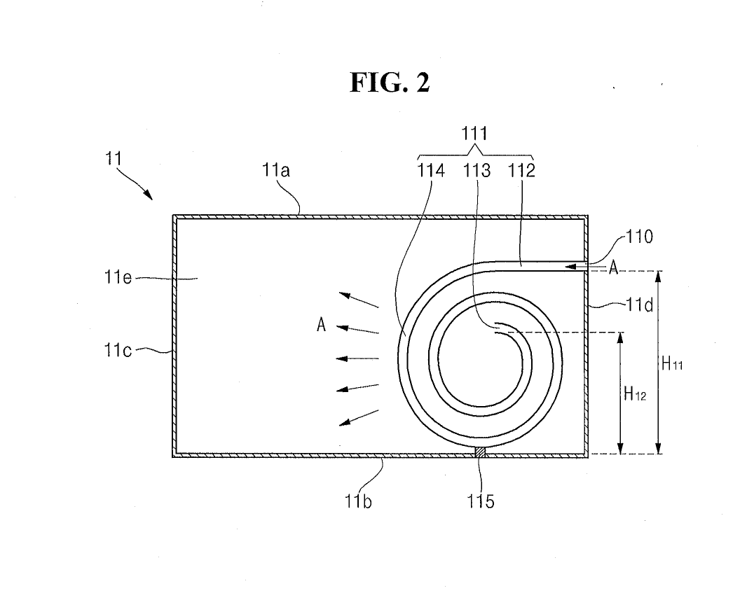

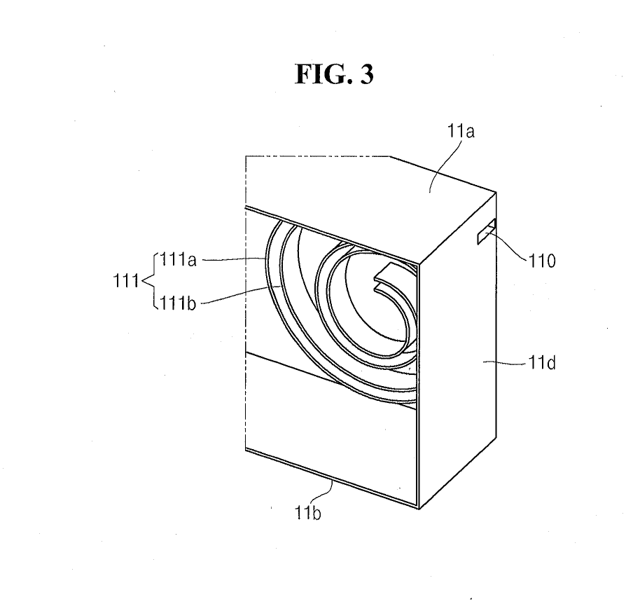

FIG. 1 is a perspective view illustrating a battery pack according to one embodiment. FIG. 2 is a cross-sectional view taken along the line B-B of FIG. 1. FIG. 3 is a perspective view illustrating some components illustrated in FIG. 2.

Referring to FIGS. 1 to 3, the battery pack according to one embodiment includes a plurality of bare cells (not shown) and a case 10. The battery pack is configured such that the bare cells are accommodated within the case 10. The battery pack having the aforementioned configuration can be employed to an electrical bicycle using a motor driven by repeating charging and discharge operations, but the use of the battery pack is not limited thereto.

The bare cells include a plurality of rechargeable secondary batteries connected in series or in parallel and supply motor-driving power to electric bicycles or motorcycles.

The case 10 includes a first cover 11 and a second cover 12. The case 10 has an internal space defined by the first cover 11 and the second cover 12. The bare cells and a battery management system (BMS) board (not shown) are installed in the internal space.

Referring to FIG. 2, the first cover 11 includes a plate-shaped bottom portion 11e and a sidewall potion including first to fourth sidewalls 11a, 11b, 11c and 11d extending from edges of the bottom portion 11e to either side.

An air hole 110 is formed in the fourth sidewall 11d to pass therethrough. The air hole 110 serves as an external air passageway. In addition, the air hole 110 can also serve as an external moisture passageway according to ambient conditions, for example, in a rainy situation. In the described technology, in order to prevent or suppress external moisture from permeating through the air hole 110, the internal surface of the air hole 110 is formed to be inclined with respect to the case 10, that is, the external surface of the fourth sidewall 11d. Here, the air hole 110 can be inclined at a predetermined angle such that the application of external air is not interfered. The predetermined angle can also be applied to another embodiment of the air hole 110.

The air guide pipe 111 communicating with the air hole 110 to guide the externally applied air to the inside of the case 10 can be formed in the bottom portion 11e.

The air guide pipe 111 includes a first pillar 111a protruding from the bottom portion 11e in a first direction (i.e., in a frontward direction) and a second pillar 111b protruding in the first direction to be spaced apart a predetermine distance from the first pillar 111a. That is to say, the air guide pipe 111 is a space between the first pillar 111a and the second pillar 111b to guide the externally applied air to the inside of the case 10. Configurations of the first pillar 111a and the second pillar 111b of the air guide pipe 111 can also be applied to other embodiments.

The air guide pipe 111 generally has a cochlea shape.

In some embodiments, the air guide pipe 111 includes a first region 112 extending from the air hole 110 and substantially horizontally formed with respect to the air hole 110. The air guide pipe 111 also includes a second region 114 extending from the first region 112 and formed to be bent in a cochlea shape in a downward direction from the air hole 110.

Here, the first region 112 is formed such that a distance H₁₁ ranging from the second sidewall 11b, which is closer to the second region 114 than the first region 112, is greater than a distance H₁₂ ranging from the second sidewall 11b to an end 113 of the second region 114. For example, the height H₁₁ of the first region 112 from the second sidewall 11b is greater than the height H₁₂ ranging from the second sidewall 11b to the end 113.

In some embodiments, the distance H₁₂ can be about 40% to about 60% of the distance H₁₁. Here, if the distance H₁₂ is less than about 40% of the distance H₁₁. it is difficult to manufacture the cochlea-shaped second region 114. If the distance H₁₂ is greater than about 60% of the distance H₁₁, it is difficult to apply the air from the outside against the moving speed of the electric bicycle.

The moisture discharge hole 115 is formed in the bent second region 114 positioned closest to the second sidewall 11b. In the described technology, it is possible to prevent a passageway of the second region 114 from clogging, caused by externally applied moisture gathering in the second region 114, by forming the moisture discharge hole 115 communicating to second sidewall 11b in the portion of the second region 114 positioned closest to the second sidewall 11b. Accordingly, the externally applied moisture is exhausted to the outside of the case 10 through the moisture discharge hole 115, thereby allowing the air to easily flow through the second region 114.

A filtering device (not shown) for improving the effect of discharging moisture to the outside of the case 10 can further be provided in the moisture discharge hole 115.

Meanwhile, like in the first cover 11, an air hole 120 is formed at one side of the sidewall portion of the second cover 12, and an air guide pipe (not shown) communicating to the air hole 120 is formed in a bottom portion (not shown).

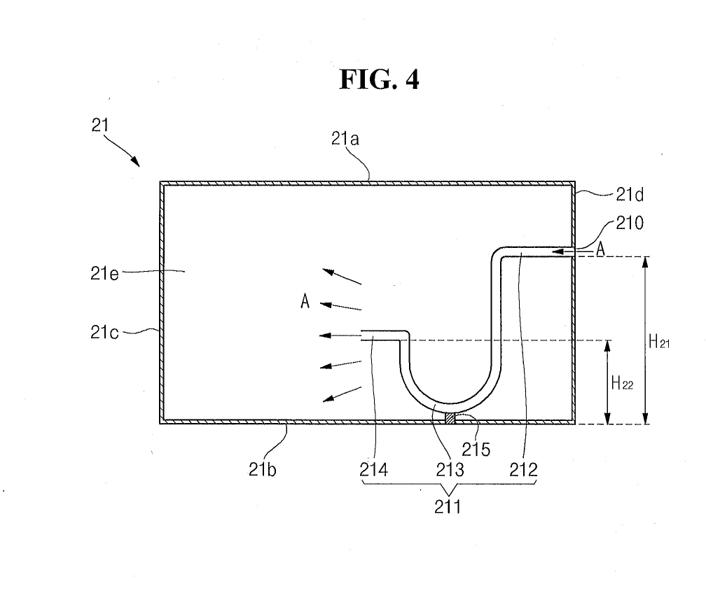

Hereinafter, modified embodiments of an air guide pipe 111 formed in the first cover 11 of the battery pack shown in FIGS. 1 to 3 will be described with reference to FIGS. 4 to 8. FIGS. 4 to 8 illustrates only configurations of first covers 21, 31, 41, 51 and 61 respectively having bottom portions 21e, 31e, 41e, 51e and 61e and first to fourth sidewalls 21a-21d, 31a-31d, 41a-41d, 51a-51d and 61a-61d. However, it is obvious that second covers (not shown) respectively coupled to the first covers 21, 31, 41, 51 and 61 can also include the same air guide pipe (not shown) as in the first covers 21, 31, 41, 51 and 61.

FIG. 4 is a cross-sectional view illustrating another embodiment of the battery pack shown in FIG. 2.

Referring to FIG. 4, an air guide pipe 211 of the battery pack according to another embodiment is configured to have a “U” shape.

The air guide pipe 211 includes a first region 212 extending from an air hole 210 and substantially horizontally formed with respect to the air hole 210. The air guide pipe 211 also includes a second region 213 extending from the first region 212 and formed to be bent in a cochlea shape in a downward direction from the air hole 210. The air guide pipe 211 further includes a third region 214 extending from the second region 213 and substantially horizontally formed with respect to the first region 212.

A moisture discharge hole 215 communicating to a second sidewall 21b positioned closest to the second region 213 is formed in the second region 213. The moisture discharge hole 215 is formed in a portion of the bent second region 213, which is the closest to the second sidewall 21b. In some embodiments, it is possible to prevent a passageway of the second region 213 from clogging, externally applied moisture gathering in the second region 213, by forming the moisture discharge hole 215 in the portion of the second region 213, which is the closest to the second sidewall 21b. Accordingly, the externally applied moisture is exhausted to the outside of the second sidewall 21b through the moisture discharge hole 215, thereby guiding the air to easily flow through the second region 215.

A filtering device (not shown) for improving the effect of discharging moisture to the outside of the second sidewall 21b can further be provided in the moisture discharge hole 215.

The third region 214 is formed such that a distance H₂₂ ranging from the second sidewall 21b of the sidewall portion, which is closer to the second region 213 than the first region 212, is less than a distance H₂₁ ranging from the second sidewall 21b to the first region 212. For example, in order to facilitate the smooth flow of the externally applied air, the height H₂₂ of the third region 214 is less than the height H₂₁.

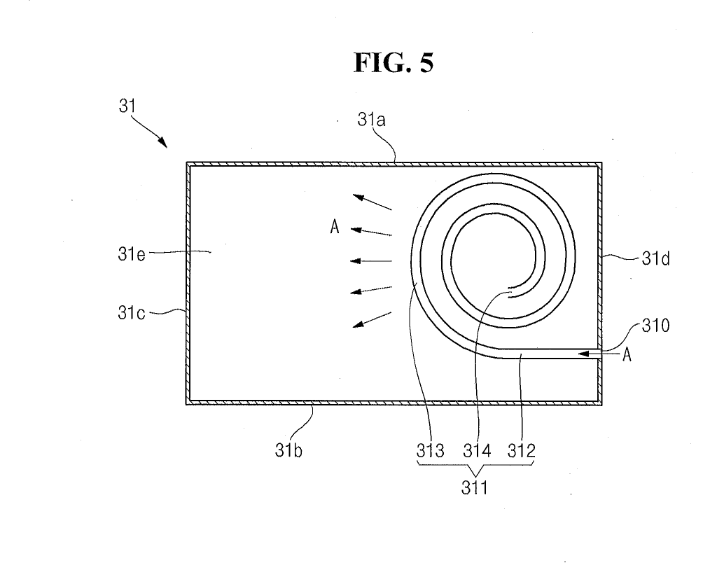

FIG. 5 is a cross-sectional view illustrating another embodiment of the battery pack shown in FIG. 2.

Referring to FIG. 5, an air guide pipe 311 of the battery pack according to another embodiment is generally configured to have a reversed cochlea shape, which is contrary to the air guide pipe 111 of the battery pack according to one embodiment.

The air guide pipe 311 of the present embodiment includes a first region 312 extending from an air hole 310 and substantially horizontally formed with respect to the air hole 310. The air guide pipe 311 also includes a second region 313 extending from the first region 312 and formed to be bent in a cochlea shape in an upward direction from the air hole 310.

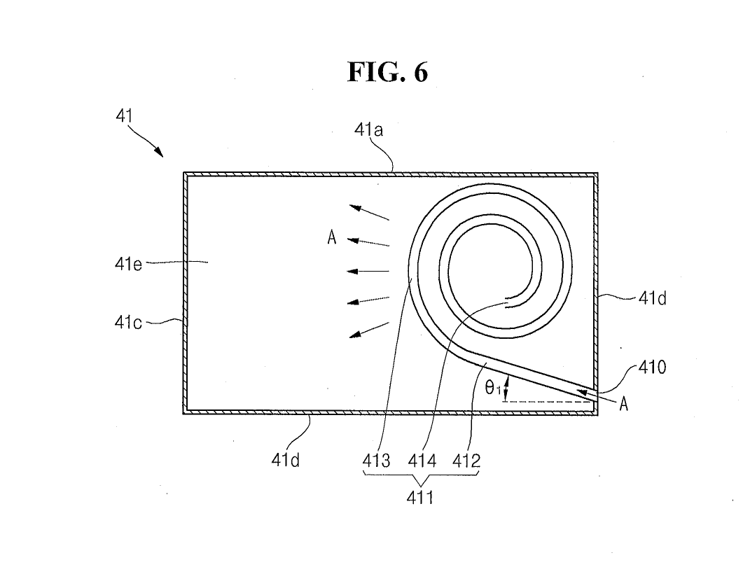

FIG. 6 is a cross-sectional view illustrating another embodiment of the battery pack shown in FIG. 2.

Referring to FIG. 6, an air guide pipe 411 of the battery pack according to another embodiment is generally configured such that the first region 312 is inclined with respect to the second sidewall 31b.

The air guide pipe 411 of the present embodiment includes a first region 412 extending from an air hole 410 and inclined with respect to the air hole 410. The air guide pipe 411 also includes a second region 413 extending from the first region 412 and formed to be bent in a cochlea shape in an upward direction from the air hole 410.

The first region 412 is formed to be inclined at a predetermined angle θ with respect to the second sidewall 41b. The predetermined angle θ can be in a range of about 10 degrees to about 45 degrees. If the first region 412 is inclined with respect to the second sidewall 41b at an angle of about 10 degrees or less, the effect of preventing moisture from being externally applied can be substantially negligible. If the first region 412 is inclined with respect to the second sidewall 41b at an angle of about 45 degrees or greater, it can be difficult to apply the air from the outside.

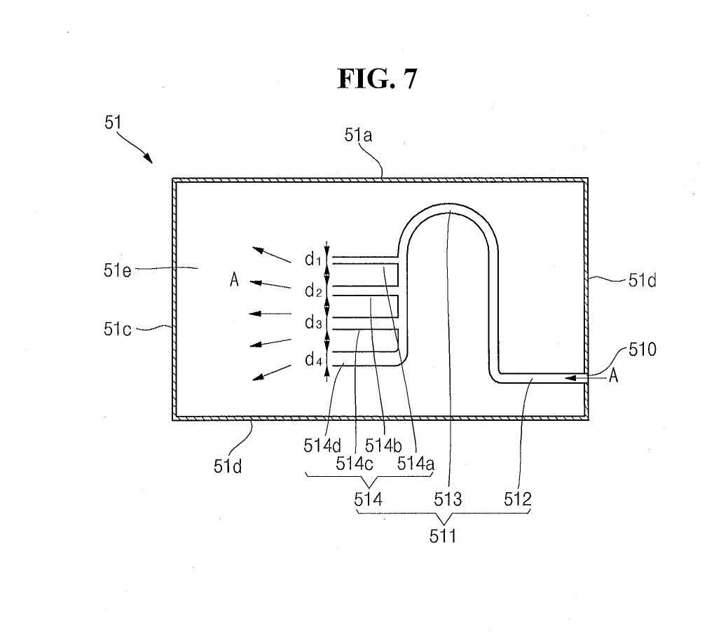

FIG. 7 is a cross-sectional view illustrating another embodiment of the battery pack shown in FIG. 2.

Referring to FIG. 7, an air guide pipe 411 of the battery pack according to another embodiment is generally configured to have a reversed “U” shape, which is contrary to the air guide pipe 211 of the battery pack according to another embodiment in view of configuration.

The air guide pipe 511 of the present embodiment includes a first region 512 extending from an air hole 510 and substantially horizontally formed with respect to the air hole 510. The air guide pipe 511 also includes a second region 513 extending from the first region 512 and formed to be bent in an upward direction from the air hole 510. The air guide pipe 511 further includes a third region 514 extending from the second region 513 and substantially horizontally formed with respect to the first region 512.

The third region 514 includes one or more dispersion regions 514a, 514b, 514c and 514d spaced a predetermined distance apart from each other and sequentially arranged in substantially parallel with the first region 512. Here, the dispersion regions 514a to 514d are formed to have vertical widths d1, d2, d3 and d4 sequentially increasing in a lengthwise direction. In the present embodiment, since the one or more dispersion regions 514a to 514d having the vertical widths sequentially increasing in a lengthwise direction are provided in the third region 514, the externally applied air is substantially uniformly dispersed in a case through the respective dispersion regions 514a to 514d, thereby implementing an improved heat-dissipating effect.

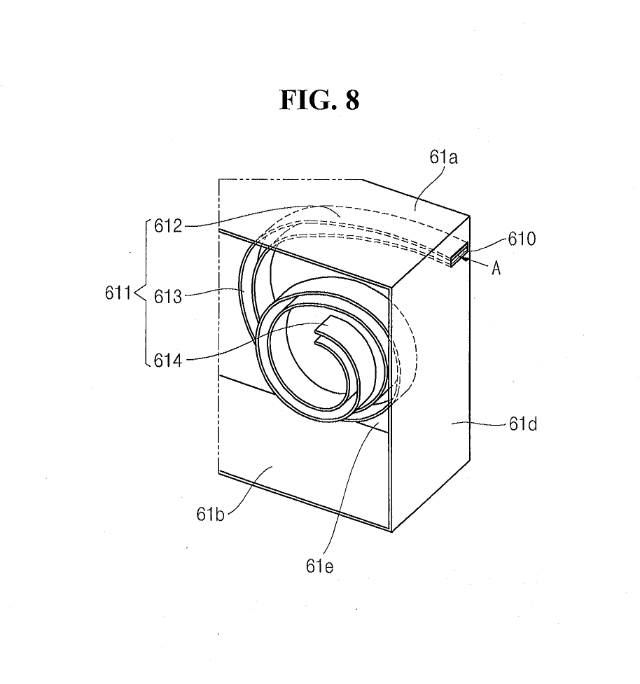

FIG. 8 is a cross-sectional view illustrating another embodiment of the battery pack shown in FIG. 2.

Referring to FIG. 8, an air guide pipe 611 of the battery pack according to another embodiment is generally configured to have the same cochlea shape as the air guide pipe 111 of the battery pack.

The air guide pipe 611 of the present embodiment includes a first region 612 extending from an air hole 610 to be spaced apart from a bottom portion 61e and substantially horizontally formed with respect to the air hole 610. The air guide pipe 611 also includes a second region 613 extending from the first region 612 to be spaced apart from the bottom portion 61e and formed to be bent in a cochlea shape in a downward direction from the air hole 610.

Here, the first region 612 is formed such that a distance ranging from the second sidewall 61b of a sidewall portion, which is closer to the second region 613 than the first region 612, is greater than a distance ranging from the second sidewall 61b to an end 614 of the second region 613. For example, a height of the first region 612 from the second sidewall 61b is greater than a height ranging from the second sidewall 61b to the end 614. In some embodiments, the distance between the end 614 and the second sidewall 61b can be about 40% to about 60% of the distance between the first region 612 and the second sidewall 61b. Here, if the distance between the end 614 of and the second sidewall 61b is less than about 40% of the distance between the first region 612 and the second sidewall 61b, it is difficult to manufacture the cochlea-shaped second region 613. If the distance between the end 614 and the second sidewall 61b is greater than about 60%, it can be difficult to forcibly apply the air from the outside against the moving speed of the electric bicycle.

The aforementioned battery pack according to the described technology includes the air hole and the air guide pipe formed in the case equipped with both a waterproof capability and a heat-dissipating capability. Therefore, it is possible to prevent moisture from being externally applied and a heat-dissipation effect can be achieved through the externally applied air.

While the inventive technology has been particularly shown and described with reference to exemplary embodiments thereof, it will be understood by those of ordinary skill in the art that various changes in form and details can be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A battery pack, comprising:
a plurality of bare cells; and
a case including i) a bottom portion including an air guide pipe and ii) a sidewall portion extending from the bottom portion so as to form a space accommodating the bare cells, wherein the sidewall portion has an air hole passing therethrough, and
wherein the air guide pipe is configured to transfer air received from the environment to the interior of the case via the air hole.

2. The battery pack of claim 1, wherein the air guide pipe comprises a first pillar protruding from the bottom portion in a first direction and a second pillar protruding in the first direction and spaced apart from the first pillar.

3. The battery pack of claim 1, wherein the sidewall portion has a first sidewall, wherein the air guide pipe comprises i) a first region extending from the air hole to be substantially horizontal with respect to the air hole and ii) a second region extending from the first region and formed to be bent in a substantially cochlea shape in an upward or downward direction from the air hole, wherein the second region is further formed such that a distance between the first sidewall and an end of the second region is about 40% to about 60% of a distance between the first sidewall and the first region, and wherein the first sidewall is closer to the second region than the first region.

4. The battery pack of claim 3, wherein the second region has a moisture discharge hole i) formed in a portion of the second region positioned closest to the first sidewall and ii) configured to discharge moisture to the outside of the first sidewall.

5. The battery pack of claim 3, wherein the first region is inclined at a predetermined angle with respect to the first sidewall.

6. The battery pack of claim 1, wherein the air guide pipe has a substantially U-shape and comprises i) a first region extending from the air hole to be substantially horizontal with respect to the air hole, ii) a second region extending from the first region to be bent in an upward or downward direction from the air hole, and iii) a third region extending from the second region to be substantially horizontal with respect to the first region, wherein the third region is further formed such that a distance between the first sidewall and the third region is less than a distance between the first sidewall and the first region, and wherein the first sidewall is closer to the second region than the first region.

7. The battery pack of claim 6, wherein the second region has a moisture discharge hole i) formed in a portion of the second region positioned closest to the first sidewall and ii) configured to discharge moisture to the outside of the first side wall.

8. The battery pack of claim 6, wherein the third region comprises one or more dispersion regions spaced apart from each other and sequentially formed to be substantially parallel with the first region, and wherein the dispersion regions have vertical widths sequentially increasing in a lengthwise direction.

9. The battery pack of claim 1, wherein the air hole has an internal surface inclined with respect to an external surface of the case.

10. The battery pack of claim 1, wherein the bare cells have a first side and a second side opposite to the first side, wherein the case includes a first cover and a second cover covering the first and second sides, and wherein the air hole and the air guide pipe are provided in the first and second covers.

11. A battery pack for an electric transportation device, the battery pack comprising:
a plurality of bare cells; and
a case including a first cover and a second cover opposite to the first cover, wherein the case is configured to accommodate the bare cells, wherein each of the first and second covers includes i) a bottom portion including an air guide pipe and ii) a sidewall portion extending from the bottom portion and having an air hole, and wherein the air guide pipe is configured to transfer air received from the environment to the interior of the case via the air hole.

12. The battery pack of claim 11, wherein the air guide pipe comprises a first pillar protruding from the bottom portion in a first direction and a second pillar protruding in the first direction and spaced apart from the first pillar.

13. The battery pack of claim 11, wherein the sidewall portion has a first sidewall, wherein the air guide pipe comprises i) a first region extending from the air hole to be substantially horizontal with respect to the air hole and ii) a second region extending from the first region and having a spiral shape.

14. The battery pack of claim 13, wherein the second region has a moisture discharge hole i) formed in a portion of the second region positioned closest to the first sidewall and ii) configured to discharge moisture to the outside of the first sidewall.

15. The battery pack of claim 13, wherein the first region is inclined at a predetermined angle with respect to the first sidewall.

16. The battery pack of claim 11, wherein the air guide pipe has a substantially U-shape and comprises i) a first region extending from the air hole to be substantially horizontal with respect to the air hole, ii) a second region extending from the first region to be bent in an upward or downward direction from the air hole, and iii) a third region extending from the second region to be substantially horizontal with respect to the first region, wherein the third region is further formed such that a distance between the first sidewall and the third region is less than a distance between the first sidewall and the first region, and wherein the first sidewall is closer to the second region than the first region.

17. The battery pack of claim 16, wherein the third region comprises one or more dispersion regions spaced apart from each other and sequentially formed to be substantially parallel with the first region, and wherein the dispersion regions have vertical widths sequentially increasing in a lengthwise direction.

18. The battery pack of claim 11, wherein the air hole has an internal surface inclined with respect to an external surface of the case.

19. The battery pack of claim 11, wherein the bare cells have a first side and a second side opposite to the first side, wherein the case covering the first and second sides, and wherein the air hole and the air guide pipe are provided in the first and second covers.

20. The battery pack of claim 11, wherein the electric transportation device comprises an electric bicycle, an electric motorcycle or an electric vehicle having at least four wheels.
